(19) United States
(12) Patent Application Publication
(10) Pub. No.: US 2006/0063586 A1
(43) Pub. Date: Mar. 23, 2006

(54) Electronic value marking for wagering chips

(75) Inventors: Peter Krenn, Neufeld (AT); Ernst Blaha, Tullnerbach (AT)

Correspondence Address: Mark A. Litman & Associates, P.A.;Suite 205, 3209 West 76th St., York Business Center, Edina, MN, 55435, US

(73) Assignees: Shuffle Master, Inc.; Shuffle Master GmbH & Co KG

(21) Appl. No.: 10/948,624

(22) Filed: Sep. 23, 2004

(51) Int. Cl. G06F 19/00; G06F 17/00

(52) U.S. Cl. 463/25

(57) ABSTRACT

Multicolored casino wagering chips are assigned temporary values and those values are read in a first device then transmitted to an external computer where they can be accessed by a separate device, such as a chip sorter to determine chip values and value flow during a casino table game. A single color chip is temporarily associated with a chosen value for that color chip, and the value/chip relationship is provided to all systems that use that relationship in assessing game performance, wins, losses, payouts, record keeping, and security for the table game. In one embodiment of the technology described herein, a set of opposed slots on a rack is provided, with a single color of chip and an electronic marker positioned on an opposed pair of slots. The marker sends out a signal regarding the temporary value associated with a color chip, or a location corresponding to a color, and that sent value is used by all automated systems on or about the gaming table to assign value to that color chip. At the conclusion of play with a particular color of chip, all the chips are returned by the player, the chips repurchased, and the value is erased from the records for that particular chip. The markers and chips may be displayed on the rack for visual inspection during play.

### BACKGROUND OF THE INVENTION

1. Field of the Invention

The present invention relates to chips or tokens used to wager at a casino, particularly to chips that may be varied in value, and most narrowly to chips that may be used in the play of roulette.

2. Background of the Art

In casinos, there are different chips that are used throughout the casino. Most chips are portable from one table to another, and come in standard denominations of, for example, $1, $5, $25, $100, $500, etc. The denominations of chips are differentiated by the alphanumerics on the chips and the color of the chips, particularly their edges and faces. Traditional colors for the chips are $1 white or silver, $5 red, $25 green, $100 black, $500 purple, etc. A problem has always existed in the use of a uniform supply of chips in certain table games. In craps, players place wagers at different locations, on the layout, depending upon the specific bets made. The bets are carefully placed by the players and are watched by the pit crew to confirm their location. The problem is more complex in bet placement with a roulette system, as the surface area/wager is significantly smaller, and many of the wagers immediately abut on the wagering space of other possible bets. This problem has been traditionally addressed by providing chips of different colors (but with a uniform value for each color) to the different players. This has worked fairly well over the years, but with the use of more electronic devices on gaming tables, this antiquated system has shown some significant weaknesses. In traditional roulette, each player chooses a chip color and then a denomination represented by that color. For example, a player might request blue chips and designate each chip to be worth $20.00. There is a special location on the layout where a blue chip is placed, with a $20.00 value marker placed on the chip. This display area provides a frame of reference for the croupier so that if the player wishes to buy more chips or cash out, the croupier will know what the chips are worth.

If a player wishes to change the value of the chip, he must first cash in his current chip inventory and then buy additional chips. This process is time consuming and slows the play of the game.

A major weakness of this system is revealed when players wish to shift the relative value of individual wagers, or where more than one player wishes to use relatively more expensive chips. Players wishing to wager higher amounts have had to maneuver considerably larger stacks of chips across the table, payouts have to be made with multiples of the size of the stacks, and there are ample instances of table slowdowns because of the difficulty in the physical transportation and counting of chips at each stop of the ball. Or, as mentioned above, the game must be temporarily shut down so a player can cash out and change his chip denomination.

The advent of increasing amounts of table electronics has also made the use of the standard chips more difficult, and attempts to add electronics directly to the chips becomes prohibitively expensive.

U.S. Pat. No. 6,753,830 (Gelbman) discloses a flexible electronic label that is capable of smart and dumb implementations as a stand-alone, remotely updateable, remotely alterable, flexible electronic label. The electronic label provides for displaying information in connection with a mammal, non-mammal, an item or location. The label includes a display assembly having electronic ink disposed on a support, one or more antennas for sending or receiving signals corresponding to one of instructions, programs, data or selected indicia to be displayed by said display assembly, a storage element in circuit with the antenna for storing the instructions, programs, data and indicia, and one or more processors for intelligently determining the indicia to be displayed by the display assembly, for controlling and coordinating operation of the label, and for generating output signals for instructing the display assembly to display the indicia. The label is also identified for use in gaming environments and in the games of roulette and blackjack.

The label is used in conjunction with an activator module that can be mounted or fixed at a selected location relative to the electronic label to promote communication there between. The activator can transmit via a transmitter a selected radio wave signal for powering the label and/or instructing the label to display particular indicia. When the integrated, remotely alterable and updateable electronic label is brought within the field or range of the activator output signal, the power antenna of the label can be activated by any power signals transmitted by the module. The power antenna receives the power signals generated by the activator module 18, which are then converted by the power converter into suitable power (e.g., current or voltage).

U.S. Pat. No. 6,733,388 (Mothwurf) describes a method for determining the total amount bet by individual players participating in multiple spins of a roulette game at a gaming table that has a chipper machine and an intelligent table terminal. The method involves interfacing the chipper sorting machine with the table terminal, allocating a chip to a patron at the terminal, counting the number of color chips sorted by the chipper machine per color, and associating the number of color chips sorted by the machine per color with the patron. The total amount bet by that patron is then determined by mathematically linking the chip value of the color chip of the patron with the number of chips of the individual color sorted by the chipper machine in the time period in which the color chip is associated with that patron. A players win/loss is determined by a pay (value-) chip movement detected by the chip tray, which is equipped with a system for detecting the instantaneous value of the chips on the chip tray, and thus also the change in value of the chip tray for any pay in or pay out, the table terminal prompts a screen asking to croupier to enter the playing position to which the pay chip movement belongs. The monitoring of movement of pay chips into and out of the chip tray together with the capture of all buy-ins (drops) and the repayment of markers thus allows the capture of the win/loss per patron. The win loss is the patron's net buy in (drop minus repayment of markers) plus the balance of the pay chips spent and received.

U.S. Pat. No. 6,506,155 (Mothwurf) describes a method for estimating the performance of a croupier at a roulette table. For each period of time the croupier is working at a roulette table, the total amount bet by individual players participating in multiple spins of a roulette game is determined. The game has a chip counting and sorting machine and an intelligent table terminal. The method involves interfacing the chipper sorting machine with the table terminal, allocating a chip color to a patron at the terminal, counting the number of color chips sorted by the chipper machine per color, and associating the number of color chips sorted by the machine per color with the patron. The total amount bet by that patron is then determined by mathematically linking the chip value of the color chip of the patron with the number of chips of the individual color sorted by the chipper machine in the time period in which the color chip is associated with that patron.

U.S. Pat. No. 6,283,856 (Mothwurf) describes a method for determining the total amount bet by individual players participating in multiple spins of a roulette game at a gaming table that has a chip sorting and counting machine and an intelligent table terminal. The method involves interfacing the chipper sorting machine with the table terminal, allocating a chip color to a patron at the terminal, counting the number of color chips sorted by the chipper machine per color, and associating the number of color chips sorted by the machine per color with the patron. The total amount bet by that patron is then determined by mathematically linking the chip value of the color chip of the patron with the number of chips of the individual color sorted by the chipper machine in the time period in which the color chip is associated with that patron.

U.S. Pat. No. 5,755,618 describes a roulette chip system providing an electronic output of the total value of chips stored in the chip tray and to automatically register any changes in the value of the chip tray.

U.S. Pat. No. 5,957,776 describes a gaming environment monitoring system that includes a chip inventory detector having a chip tray with a plurality of chips sitting therein. The chip inventory detector has a plurality of ultrasonic transducers mounted in an end thereof. One ultrasonic transducer is mounted in each cylinder or bin of the chip tray. The ultrasonic transducer transmits an ultrasound pulse. The ultrasound pulse is reflected off of the last chip in the chip tray back towards transducer. Based on the time required for the reflected pulse to reach the transducer, the number of chips in that cylinder can be determined. The transducer is controlled by a plurality of conductors that are coupled to the remainder of the table control unit. Other detectors could also be used, such as optical detectors.

U.S. Pat. No. 5,770,533 (Franchi) describes a casino operating system for controlling the flow of funds and monitoring gambling activities in a casino or a gaming establishment utilizing a network of computers, including a central computer and individual game computers. Each player receives an encoded betting card from the cashier. At the games, each player position is equipped with a control panel including a card reader into which the betting card is inserted. The control panel also includes an electronic screen and keyboard. From the control panel, the player may place a bet and perform all options available to the player in the particular game. The system records the hands dealt to each player and the winner, and credits or debits the player's betting card accordingly. In an alternative embodiment, the casino operating system allows the players to use chips to place bets instead of the above-described betting card. The chips are marked or encoded so that they can be counted once final bets have been placed to determine the amount of each player's bet. In games requiring the placement of bets in certain positions on the gaming table, each player may be provided with a betting marker used to indicate the position of his bets on the table. A touch-sensitive screen may be used whereby bets are placed by touching the desired position on the screen, or a two-way remote control console for placing bets may be provided.

U.S. Pat. No. 6,572,474 (Rudd) describes a croupier's payout calculation aid for calculating payouts for a game playable by a number of players, the game allowing a player to make multiple bets with chips of a distinguishable color that are used only by that player, at least some of the multiple bets having different payout odds as to a result determined by a spin of a rotating element, the aid including: a data-input module including identifier data entry means having a data entry button dedicated to each respective the color for entering data indicating the distinguishable color of chip corresponding to each of the number of players, chip value data entry means for entering data indicating a corresponding monetary value for each the distinguishable color of chip and, for each winning bet having different payout odds in turn, bet entry means for inputting data corresponding to the payout odds of a player's winning bet on a particular spin of the rotating element, and numeric value entry means for entering a number of chips of the distinguishable color that were wagered by the player on each of the winning bets; a computation module coupled to the data-input module and arranged to compute payout data for the player for that spin of the rotating element on the basis of entered data indicating the distinguishable color of chip, the corresponding monetary value for each the distinguishable color of chip, and each winning bet having different payment odds in turn, along with the sum of products of data corresponding to the winning-bet payment odds, and number of chips of the distinguishable color that were wagered; a display coupled to the computation module to receive the payment data and display the number of chips of the distinguishable color won by the player on the spin of the rotating device and the cumulative total of the monetary value of the chips of the distinguishable color as data is input to the data-input module.

U.S. Pat. No. 6,567,159 (Corech) describes a system for recognizing gaming chip denominations. The system includes pairs of light emitting devices P₁ through Pₙ, each pair of light emitting devices emitting light of a different color. The light is reflected off of the surface of the gaming chip, is sensed by a light detector, digitized by an analog to digital converter, and compared with stored intensity profiles for various denomination gaming chips. When a match is obtained, system issues a signal indicating the color, and thus denomination, of the gaming chip. An energizing circuit produces a constant current to ensure a constant light intensity level. An automatic adjustment circuit changes the constant current to accommodate for factors such as component aging. Adjustment circuit is controlled by a calibration feature wherein light is reflected off of a calibration surface while system is in use.

U.S. Pat. No. 6,075,217 (Kiritchenko) describes a chip sorting apparatus. The apparatus includes an article transport mechanism, a light source positioned to direct light across surfaces of transported articles, and a detector positioned to detect light reflected from such surfaces and emit signals each indicative of a spectrum of light reflected by one such article as such articles are transported. A signal analyzer compares detector signals with stored data representative of the colors of articles of a set of articles being sorted. The analyzer emits article identifying signals reflective of such comparison. The apparatus also includes a sorter that is responsive to such identifying signals and directs identified articles from the transport mechanism into appropriate ones of a set of collection stations. A method of sorting a set of articles according to color is also disclosed.

U.S. Pat. No. 3,766,452 (Burpee et al.) discloses one example of a gaming chip that is adapted to be detectable by an EAS system so as to deter stealing of gaming chips by employees. The chips have a dielectric body with an inductive wire loop imbedded in the periphery that terminates in a capacitive metallic bar. The inductive loop and capacitive bar cooperate with each other to provide a resonant electrical circuit. This resonant circuit responds to incident electromagnetic radiation at a preselected relatively high frequency to produce and radiate a unique detectable signal indicative of the presence of the chip in the incident field.

U.S. Pat. No. 5,406,264 (Plonsky et al.) describes an EAS detectible gaming chip having a disc-like body in which is disposed an amorphous magnetic marker material to simplify the structure shown in Burpee et al.

U.S. Pat. No. 4,157,139 (Bjork) describes a device for sorting discs or disc-like members of different identities (e.g. roulette chips). The device withdraws the discs from a receptacle by a conveyor and moves them in oriented succession along a sorting track where they are automatically identified and transferred by transfer devices into respective receiving spaces along the sorting track. The receiving spaces receive the discs at their lower ends so as to form stacks in the receiving spaces, the stacks being built up from their lower ends in inclined troughs forming part of the receiving spaces. Preferably each disc has its leading portion deflected upwardly as it approaches its assigned receiving space, while still retaining driving engagement with the conveyor, and the raised leading portion passes onto a disc catching member at the bottom of the receiving space, after which the disc is driven into the receiving space by the remaining engagement with the conveyor. The troughs of the receiving spaces are formed with longitudinal grooves carrying longitudinally displaceable devices engage able with predetermined numbers of discs at the upper end of the stack, such that the devices may be used to separate and remove predetermined numbers of chips from the stacks.

U.S. Pat. No. 6,685,584 (Oliver) describes a method of promoting play of a live casino card game for a group of players, the live casino card game having a computer system reading the monetary values from transponders in casino chips when placed as wagers on a table for the live card game, the method comprising: providing special casino chips to the group, each of the special casino chips having a promotion for the group encoded into its transponder, reading the promotion from the transponder of the special chip in the computer system when the special casino chip is placed by a player of the group on the table during play of the live casino card game, and enabling in the computer system the player to participate in the promotion in response to the reading.

U.S. Pat. No. 6,629,591 (Griswold et al.) describes a token for use in a cashless transaction involving an electronic device includes a token body having a coin shape. The token has a digital circuit embedded within the token body and a memory embedded within the token body that is coupled to the digital circuit. The token also includes an input/output interface embedded within the token body that is coupled to the digital circuit and which enables the digital circuit to communicate with the electronic device. A computer program is adapted to interrogate the coin-shaped token for information stored in the memory by transmitting electromagnetic signals to an antenna embedded within the token.

U.S. Pat. No. 6,581,747 (Charlier et al.) describes a chip and method of manufacturing the chip. The chip includes a flat body made of a plastic material. The flat body has at least two parallel faces and a cavity which opens to at least one of the at least two parallel faces. The cavity is adapted to receive an electronic identification device. At least one plug made of a plastic material is included. The at least one plug is adapted to be inserted into the cavity. The electronic identification is retained in the flat body when the at least one plug is inserted into the cavity. The method includes making the flat body, forming the cavity in the flat body, placing the electronic identification device in the cavity, inserting the at least one plug in the cavity, and fixing the at least one plug to the flat body.

U.S. Pat. No. 6,264,109 (Chapet et al.) describes a chip or token including a plastic cover having an external surface and a base engaging surface. A plastic base has an external surface and a cover engaging surface, the base being attached to the cover. An axial spacing projection maintains a space between the base and the cover, the axial spacing projection being disposed on the cover engaging surface of the base and including a first height. The axial spacing projection further includes one of a continuous ring and a discontinuous ring. A closure ring disposed on the base engaging surface of the cover comprises one of a continuous ring and a discontinuous ring. A peripheral annular region includes a space having a second height and is disposed adjacent an edge of the token, the peripheral annular region being defined by the axial spacing projection. The first height is approximately equal to the second height. An electronic device includes an electronic circuit that includes one of a memory containing identification, a coding information, and a transmitter-receiver having a peripheral antenna. An internal central region includes a receptacle for receiving the electronic device, the internal central region being defined by the axial spacing projection. A plastic jointing material is disposed in the peripheral annular region, wherein the plastic jointing secures the base to the cover. The closure ring includes an engaging diameter that is smaller than a diameter of the axial spacing projection such that the closure ring and the axial spacing projection engage and axially overlap one another when the cover is fixed to the base.

U.S. Pat. No. 6,021,949 (Boiron) describes a gaming or casino token or chip having a thick flat plastic body provided with a circular through-hole in which an electronic identification element is placed. The casing of the device is protected by two protective wafers. The permanent integration of the casing in the body supplemented by attaching, for example by laminating, a plastic covering sheet and in each face and of the body. This forms a monoblock rigid assembly for the electronic identification device. The device includes a memory that stores identification codes and an inductively coupled transmitter-receiver equipped with an antenna.

U.S. Pat. No. 5,735,742 (French) describes a system for tracking movement of gaming chips within a casino, wherein the gaming chips carry electronically ascertainable information about the gaming chips. The casino comprises a vault for receiving and storing gaming chips, a cashiers cage for disbursing and cashing out gaming chips, and a plurality of gaming tables. The system comprises at least one antenna associated with the vault for scanning gaming chips entering and leaving the vault, at least one antenna associated with the cashiers cage for scanning gaming chips entering and leaving the cashiers cage, and at least one antenna associated with the gaming tables, for scanning gaming chips at the tables. It is preferred that the scanning step in the vault include the step of encoding the data bank in the chip with a voidable casino security code, so that the chip may be easily invalidated automatically if desired, and that it further includes the step of recording movement of the chip between locations, so that a transactional history of the chip is preserved in a data bank carried by the chip.

U.S. Pat. Nos. 5,651,548 and 5,735,742 (French) describe a method of tracking movement of gaming chips in a casino comprising gaming chips each having an electronic circuit which transmits information, and antennas located at gaming chip placement areas. When gaming chips are placed on a first gaming chip placement area within the casino, the antenna at that first gaming chip placement area transmits a radio signal which in effect scans the electronic circuits of the gaming chips. The electronic circuits identify the gaming chips by electronically broadcasting information. Upon moving a first of the gaming chips to a second gaming chip placement area, the antenna at the second gaming chip location transmits a radio signal which scans the electronic circuit of the first gaming chip. The electronic circuit in the first gaming chip identifies the first gaming chip on the second gaming chip placement area so that the location of the first gaming chip is tracked. The gaming chip placement areas may be at various places such as on a gaming table or a gaming chip tray.

U.S. Pat. Nos. 6,464,584 and 6,186,895 (Oliver) describe an intelligent casino chip system. At least one gaming table is provided with at least one discrete player area. Two classes of intermingled gaming chips are accepted in the discrete betting areas. Each gaming chip of the first class has a first transponder containing at least value information. Each gaming chip of the second class has a second transponder containing value and class information. The computer system determines the values from each class of chip and the class information from the second transponder.

U.S. Pat. Nos. 6,296,190 and 5,166,502 (Rendleman) describe a gaming chip that includes a base ring that defines a central aperture, within which a unitary cup disposed. The cup has first and second recessed cavities therein. A transponder is disposed in one of the first and second cavities and an antenna is disposed in the other of the first and second cavities. The antenna is electrically coupled to the transponder and a cover is secured over the cup to maintain the transponder and the antenna within their respective cavities. A method for making a gaming chip is also provided.

U.S. Pat. No. 5,895,321 (Gassies) describes a gambling chip having the general shape of a disc, including two identical half-discs contact via axial spacing rings respectively located on their internal faces. The half-discs are made of rigid plastic and are fastened together by injection of a plastic seal on the edge of the chip into a peripheral annular region lying between the two half-discs. The half-discs have a central recess forming an internal central region taking an electronic identification device embedded in a wafer based on epoxy resin.

It would be desirable to provide an apparatus and method which automatically assigns a value to a chip color in a roulette game, and which transmits this information to a chip sorting device to keep an accurate inventory of wagers being lost to the house.

### SUMMARY OF THE INVENTION

Multicolored casino wagering chips are assigned temporary values according to color and those values are transmitted to a separate device, such as a game computer or network computer that is used to measure a number of chips passing through a chip sorter during a casino table game and calculate the value of the chips. A single channel of the sorter is temporarily associated with a chosen value (and color) for that channel, and the value/chip relationship is provided to all systems that use that relationship in assessing game performance, wins, losses, payouts, record keeping, and security for the table game. In one embodiment of the technology described herein, a set of opposed slots on a rack is provided, with a single color of chip and an electronic marker positioned in opposed slots. Each pair of opposed slots is assigned to a channel of the chip sorter. The marker sends out a signal regarding the temporary value of the channel, and that sent value is used by all automated systems on or about the gaming table to assign value to the color chip related to that channel. At the conclusion of play with a particular color of chip, all the chips are returned by the player, the chips repurchased, and the value is erased from the records for that particular chip. The markers and chips may be displayed on the rack for visual inspection during play.

### BRIEF DESCRIPTION OF THE FIGURES

FIG. 1 shows an embodiment of an Electronic Value Marker Tree (EVMT).

FIG. 2 shows a flow diagram for practicing certain methodologies of chip valuation according to teachings provided herein.

FIG. 3 is a schematic diagram of one preferred roulette revenue tracking system of the present invention.

### DETAILED DESCRIPTION OF THE INVENTION

Chips or tokens of sufficient color variation to be visibly observed and/or mechanically (e.g., optically) read are provided. These chips may not have to have any value indication on them, and preferably do not have any value indicia on them. These chips are associated with a system that temporarily associates the colors of chips, with a selected (e.g., player selected or casino selected) value. The color and the assigned value are typically assigned to a channel in the chip sorting machine and the associated relationship is transferred electronically to a processing system that will be used to assess game play, game performance, value transactions, wins, losses, or any other event where the value of one or more chips is to be used. A chip sorting machine reads the color of the chip, determines the number of chips of that color, and provides a total value for the chip(s) based on that number and value. The simplest example of such an event is after play of a round of a casino table game, the chips are collected, sorted, counted, and the results of that round of play are determined automatically. In a preferred form of the invention, lost wagers are swept from the table and fed into the chipper. After winning payouts are made, a number of chips equal to the winning wagers are combined with the wagers swept and all wagers are therefore accounted for in the final count. Another example of use would be where a dealer indicates a specific value of winning for a player (having a specific color of chip), commands a chip delivery system to provide a specific payout to that player, and the delivery system counts out the specific number of chips of that color (and assigned value), and delivers that number of chips of that color to the dealer for delivery to the player.

A system is provided that temporarily associates a specific valuation to a wagering token of a particular color or other measurable physical characteristic (such as shape, size, pattern, etc.), and in one embodiment the associated value can be added or changed without any physical, electronic, or data content modification of the wagering token or chip. The associated value is provided from an electronic assembly that is physically located adjacent to the corresponding chip. In other forms of the invention, the device associates a measurable physical characteristic such as shape with a specific value and provides that tied value/color information to other electromechanical or optomechanical, or electro-optical equipment that can use that value/color information in part of the equipments function.

In one example of the invention, the presently described technology performs by a first device (an EVMT, as described below) associating a specific color with a specific value for the chip, and then providing that information to other devices that can use that information to measure wagering activity. In one example, each specific channel of the chip tree is assigned a chip color, and that association remains constant from round to round of play. A chip tree is provided that permanently assigns a color of chip to a position in the tree. By inserting an electronic marker in a slot adjacent to a particular chip, that color becomes known to represent that denomination. The information may be updated at any time by the first device, and the other devices might be able to, can or must query the first device to use the information. The structure can vary in complexity and provide varying levels of security against tampering as the system changes. Among the various design, performance and structural formats are contemplated:

1) A system can be provided where colored chips are placed into a chip reading device that is separate but in communication with an electronic value marker tree (hereinafter EVMT). The EVMT may or may not read information from the chip (the information may be as simple as the color of the chip). Information can optionally be entered into the system identifying a specific player for that color. A value marker may be inserted into a slot adjacent to the chip, creating an electronic association between the assigned channel and the selected denomination, i.e., $10.00 per chip. The chip may thereafter be displayed in association with the selected value marker on the EVMT or associated hardware (e.g., a separate rack, in full view of the players). The information at least relating to chip color and chip value (and possibly also player position or player identification) is then transmitted to associated other devices (e.g., such as a chip sorter or to an external computer) that can use that information as part of an analysis of wagering activity. A simple design would include slot racks for multiple color chips that displays chips when they are inserted into the slot rack, and also displays the selected values associated with them. For example, a top slot could have a $100 value, a second slot $50, a third $25, a fourth $10, a fifth $5, and a last slot have a value of $1. Each chip inserted into that single slot would be displayed and would have the specific associated value as displayed on the value marker. The dealer could reprogram the value for each slot and add new or different visual indicators (if desired) to display the value of the chips.

2) A system can be provided that provides multiple pairs of opposed slots or tracks for inserting opposed pairs of a) chips (of a predominantly single color or a predominantly single color other than a background color or colors, such as black and/or white and/or gray as the background) and b) electronic boards or chip boards (referred to as value markers) that identify specific values that are to be provided to other devices. By inserting a chip of a predominant color into a slot designated for that color chip, and by inserting the chip board or electronic “marker” of a specific value into opposed slots or tracks, combined color/value information for any position on the rack can be programmed into the EVMT according to the techniques taught herein. Although the marker tree could read the color of the chip and send a signal representative of that color to a computer or to a chip sorting machine in order to assign a color to a channel, it is preferred that colors are assigned to designated slots in the tree, so that each channel always sorts the same color chip.

A review of the Figures can assist in a better understanding and appreciation of the technology described herein.

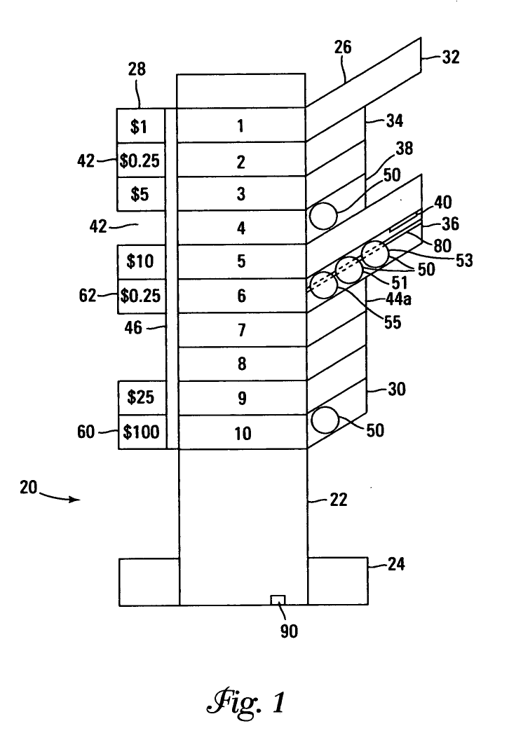

FIG. 1 shows a schematic rendition of a frontal view of an EVMT system 20 according to one embodiment of this technology. The EVMT tree 20 comprises a vertical trunk or support 22 and a supporting base 24. The tree 20 is marked to show ten player chip positions 1-10, each position corresponding to a channel in a corresponding chip sorting device (not shown). There are adjacent opposed chip accepting tracks 26 and marker accepting tracks 28 on the vertical support 22. Individual wagering chips 50 are shown in some of the chip accepting tracks 26. For example, wagering chip accepting track 30 shows a single wagering chip 50 as part of an opposed pair of a wagering chip and electronic marker 60 (a $100 marker) in position 10 on the EVMT system 20. The color of the individual wagering chip 50 in track 30 would be pre-assigned to position 10 or alternately can be read (as with an infrared scanner or color reader (see 40 in wagering chip track 36), or by electronics in electronic marker 60 that has an optical or other communication channel to the individual chip 50 in wagering chip track 30. In the latter case, the electronic marker 60 alone, or in cooperation with an infrared color identification system (not shown) built into the vertical support 22, into the opposed wagering chip track 30 (again see 40 in track 36) or into the marker 60 itself will cooperate to provide information on color/value association that will be output (e.g., through data port 90) to other devices such as an external computer or a processor of a chip sorting device. The simplest method would include pre-assigning colors to each position 28, which in turn is associated with assigned channels in the chip sorter. The wagering chip accepting tracks 26 are shown by way of example as having different lengths, as in tracks 32 and 34. The tracks may be of uniform length on a single EVMT 20 or as shown in FIG. 1, have different lengths. One track 30 is shown of a length that will accommodate a single chip 50. Another track 36 is shown as able to accommodate at least three individual wagering chips 50. In a track that accommodates multiple chips, a mechanism must be provided that can identify the different colors of the wagering chips in that individual track and provide that information so that it can be associated with a value and sent as a signal relating to color and value. This can be done in a number of ways. As non-limiting examples of the ways in which this color data can be provided are a color sensor in the marker (e.g., 62) or in the vertical support 22 level 6 that can sense color in all chips present in track 36, a color sensing strip 80 inside of the track 36 that can sense multiple colors on multiple chips 50 in the track 36, or a color sensor 40 that reads the color of individual chips as they are inserted into the track 36 when the individual chips 50 pass the sensor 40. A larger track 36 accommodating multiple chips might well be used with denominations of chip value that are more common, such as $0.25 or $1.00 value chips. The players playing with chips 51 and 53 would not have a visual indication of denomination as would chip 55 (marker 62). The use of tracks that accept multiple wagering chips could provide either more economy of space vertically necessitating fewer tracks) or allow for more than 10 players at a table when there are only 10 tracks. (The chip sorting machine would also need to have more channels.) The individual electronic markers (e.g., 60 and 62) are chip boards or other electronic elements that contain at least value information for one or more chips that can be transmitted to other devices, for example through port 90 to an external computer or other device or by wireless transmission to other devices with wireless receivers. The individual electronic markers (e.g., 60 and 62) may be permanently attached to the EVMT system 20 (which is less preferred because color reading sensors are then necessary in the chip accepting tracks 26) or may be removable and replaceable by the dealer or the casino. In a structure where all wagering chip accepting tracks 26 are of equal size and accept only single wagering chips, there must be multiple marker chips of the same value available to the croupier for a common value to be assigned to the wagering chips. For example, there may be a need for 10 markers for a value of $1.00, 10 markers for a value of $0.25, etc., so that if all ten players wish to wager with the same value of chip, they can all be accommodated. Wagering Chip track 34 is shown with no chips therein and a marker having a value content of $0.25 in the opposed marker track 42. The absence of a chip may authorize the EVMT system to either indicate that no signal is to be sent from any reporting function associated with tracks 34 and 42, or send a signal that there are no chips in track 34 even though a value of $0.25 is associated therewith. Track 38 is shown with a single chip 50 therein, but space 42 in the series of electronic marker tracks 28 does not have a marker therein. The absence of a marker may indicate to the EVMT system that the particular channel is not in use, that no value has been assigned to the individual chip 50 in wagering chip track 38, that the specific color of the individual chip in track 38 has not been assigned a value, or any other signal that is thought to be appropriate.

The EVMT system may be configured in any of a number of ways limited only by available technology. For example, the signal carrying the color and/or channel and associated value information relating to individual colors of wagering chips sent by the EVMT system to other devices may be sent by a port connection or by wireless connection by any electromagnetic transmission method. The transmitter for the information may be located in the individual markers, in the individual marker tracks, or there may be a single EVMT transmitter that receives internal signals from the channel and the markers (which may be one and the same or different as described above) and then transmits the information to other devices by port or wireless connection. The signals may be sent directly to other system components such as a chip sorter or external computer. The data may be transmitted via a network connection, either wired or wireless.

The operation of the system may also be varied according to the individual wishes and business practices of the casinos using the system. At the beginning of play or the opening of a table, some or all chips will not be in the EVMT system and will not have any value associated with their specific color. When a player arrives, the player will select a color that will be that player's color chip, and will inform the pit crew or dealer of the value that is to be assigned to that player's chips. The dealer will then insert a chip of the selected color into a preselected chip accepting track and will also insert an electronic marker into the EVMT or use a track with an appropriate electronic value marker built into it, and an activation switch (either on/off or allowing/enabling data introduction or transmission) may be optionally provided. The information (comprising a specific color of chip and/or the channel number and a value associated therewith) is then able to be provided to other devices within the casino. The information may be immediately transmitted to one or more other devices (e.g., a chip reading tray, a table analyzer system with visual input, a chip sorter, a bet recognition system, a table game processor, a central game processor, and the like) or may be transmitted upon command (e.g., at the beginning or end of each spin by a roulette wheel, at a signal that a spin has been completed, upon dealer command, upon insertion of chips into a tray, upon insertion of chips into a sorter, upon completion of the collection of chips in individual channels after sorting, etc.). The command may be automatic or manually (dealer) input. The other devices use this information according to their individual functions. For example, a chip sorter of the invention will identify how many chips of each color have been collected after each roll of the ball and will either compute that value and send it to a computer (table, pit or casino central) for the computer to receive, store and or analyze, or the chip sorter will provide only the data regarding the number of chips of a specific color and the computer that has also received the color/value associated data will compute the value of that number of chips. The final data regarding the value of wagers placed can be stored in the computer for later use or used immediately for any casino directed purpose. For example, the computer can determine a total value of wagers made/spin, total value of wagers made/channel/spin, total value of wagers made/time, total value of wagers made/session, total value of wagers made/player/time, and provide any other analytical format from available information. If the winning wagers are not returned to the chip sorter, various measures of wagers lost to the house can instead be tabulated. This type of information can be very important to the casino in maximizing personnel usage and in monitoring player and dealer activity, as well as monitoring individual game activity. When a player wants to cash in chips and end the individual player's session, the chips are counted by the chip sorter, a final tally of player's holdings in chips determined, that information provided to the table crew, and the player can be paid in standard casino chips or with a refundable ticket or account credit. If the tally shows that all chips of a specific color have been returned to the table, the chips valuation for that color can be deactivated. This deactivation can be done in a number of ways, such as by removing that particular color chip from the EVMT which would (automatically or by dealer command) cause a signal to be sent to the other devices of a change in valuation for that color (to, in essence, make it valueless), removing the electronic marker from the opposed marker track EVMT which would (automatically or by dealer command) cause a signal to be sent to the other devices of a change in valuation for that color (to, in essence, make it valueless), or by manual activation of a function that would deactivate an opposed pair of tracks (which would be useful for single chip tracks) EVMT which would (automatically or by dealer command) cause a signal to be sent to the other devices of a change in valuation for that color (to, in essence, make it valueless). The deactivation of an opposed pair could be effected by a button or switch available to the dealer that would be used, and then the chip in that pair of opposed tracks removed and/or the electronic marker removed. At this point, only those wagering chips in play will still have retained values within the system parameters. The player may arrange for chips that he has removed from the table to retain their value for a limited period of time, in expectation of the player's return to the table, or in expectation that the player will cash out in a cage within a given timeframe.

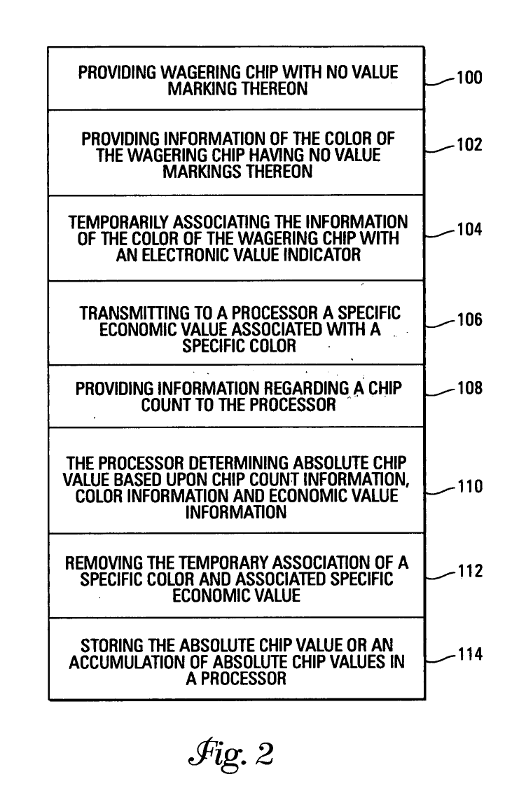

As shown in FIG. 2, there are numerous aspects to the practice of the technology described herein, non-limiting examples of which include but are not limited to providing a wagering chip with no value 100 and providing the chip color information 102. A wagering chip value association marker comprising a chip board may be provided and can be positioned adjacent to a colored casino wagering chip, the chip board containing information related to an absolute economic value that will be assigned to a casino wagering chip, that value information being capable of being associated with specific color information. The value is temporarily assigned to the chip 104. There may be circuitry capable of receiving data from a color sensor and being able to forward that data from the color sensor in a format associating a determined color with the absolute economic value, and the color sensor may even be part of the electronic marker. The marker may have transmission capability for the value information and/or for the color information. This information may be transmitted to a processor 106. Also described herein is an electronic value marking tree comprising multiple chip boards containing information related to an absolute economic value that can be assigned to each color of a wagering chip, a receptor for a sample wagering chip that informationally associates a wagering chip with a single chip board containing information related to an absolute economic value, a color identifier, and an informational communication component having external communication capability. The term absolute economic value means that there is a specific value, such as $1.00, 100 Yen, 10 Euros, 5 Rubles or the like, associated with the color as a true value. The chip boards that contain information related to an absolute value may also contain a color sensor embedded onto the same board. There would be a direct visual transmission capability between the light sensor and the wagering chip so that the color of a chip positionally located with respect to the sensor could be determined and the color information forwarded. The sensor could, for example, emit radiation (white light, infrared light, specific spectra or combinations of electromagnetic radiation, and have a sensor that can interpret returning electromagnetic radiation as reflected from a particular color. This can be easily done by training the equipment at each casino site, using the actual colors of wagering chips that each casino would use. As noted earlier, the chipboards containing information related to an absolute value may be manually removable from and insertable into marker receptors on the marker tree. They may slide, snap, or plug into place according to various connection designs available. The information communication component may be communicatively linked to the color identifier and to the chip boards containing information related to an absolute value, and the information communication component is capable of communicating information from the color identifier and the single chip board so that an absolute economic value is associated with an individual color of wagering chip. Communication from the combined component system is preferably wireless. The wagering chip acceptors can receive only a single wagering chip at a time or multiple wagering chips at one time. The marker tree may have its information communication component in ultimate information communication with a various other devices and processors around the casino, such as a chip sorter. One method that can be practiced is to temporarily assign a value to individually colored wagering chips by positioning the colored wagering chip adjacent to an electronic source of value information, sending both color information from the wagering chip and value information from the source to a processor, and basing valuation of wagering chips that are counted in a finite period of time upon both the color information and value information assigned to that color. Pairs of slots may be provided. A colored wagering chip is inserted into a first slot of a pair of slots comprising a wagering chip acceptor, the electronic source comprises a chip board having electronic information and is inserted into a second slot of an opposed pair of slots and comprises a chip board receptor, and color information is obtained from the wagering chip acceptor and value information is obtained from the electronic source to form color-value information, and that color-value information is transmitted to a device external to the electronic source. In one example, the chipboards are marked externally with the denomination to be programmed, in a manner visible to the croupier and players. Transmitted color-value information, as well as chip count 108 is sent to a data processor that has access to totals of chips according to color. The data processor calculates an absolute chip value 110 of wagering chips for a particular color based upon the color-value information and a total of chips of a color included in the color-value data.

The EVMT may basically be described as a physical and information system for receiving casino wagering chips that contain an electronic chip and a visible marking function identifying the value of the chip and providing information to other devices related to the value of specific color wagering chips. A preferred EVMT is a relatively vertical device having two opposed inserts as the ‘branches’ on the tree. One insert (see attached FIG. 1 showing ten opposed inserts on opposite sides of the center support) has an individual color wagering chip in it, and the other opposed insert has the individual electronic “marker” (electronic chip board) inserted. As each player arrives at a table, a specific color chip (having no initial value) is assigned to that player. A marker is provided in a slot opposed to a slot or track for a specific color of chip, and this marker provides information (e.g., through infrared detection) that is sent from the Tree to a processor (e.g., lap top, chip sorter, chip reading chip tray, game controller, central processing station etc.) to assure that a specific value is assigned to specific chip colors. Flow of chips in the game can be assessed based on the actual values assigned to each chip color, and the activities of individual players can be tracked.

The method may include the steps of removing a temporary value and color 112, and storing chip values (total, by color, per unit of time, etc.) 114 in a processor.

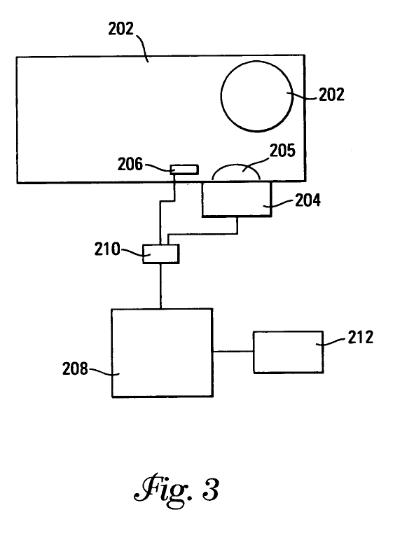

FIG. 3 is a schematic view of a system of the present invention. The system includes a gaming table 200 with a conventional roulette wheel 202, a chip sorting machine 204 with a hopper 205 and an EMVT 206. Both the EMVT and the chip sorting machine are connected to a game computer 208 through switch 210. The system may also include a monitor 212. Information that associates chip color and/or the channel assigned to a chip color is fed into the computer 208, as well as chip counts per color from the chip sorter 204. The computer 208 then determines the total of amounts wagered. According to one aspect of the invention, all losing wagers are fed into hopper 205 as well as winning wagers, after the appropriate payouts are made.

The chip inventory system of the present invention may be combined with player tracking system in order to obtain betting activity by player. Also, other types of data such as buy-ins, cash-outs, the use of house credit or cash play data may be captured with the help of a player tracking system combined with the chip inventory methods and apparatus of the present invention.

All of the apparatus, devices and methods disclosed and claimed herein can be made and executed without undue experimentation in light of the present disclosure. While the apparatus, devices and methods of this invention have been described in terms of both generic descriptions and preferred embodiments, it will be apparent to those skilled in the art that variations may be applied to the apparatus, devices and methods described herein without departing from the concept and scope of the invention. More specifically, it will be apparent that certain elements, components, steps, and sequences that are functionally related to the preferred embodiments may be substituted for the elements, components, steps, and sequences described and/or claimed herein while the same of similar results would be achieved. All such similar substitutions and modifications apparent to those skilled in the art are deemed to be within the scope and concept of the invention as defined by the appended claims.

What is claimed:

1. A wagering chip value association marker comprising a chip board that can be positioned adjacent to a colored casino wagering chip, the chip board containing information related to an absolute economic value that will be temporarily assigned to a casino wagering chip, that value information being capable of being associated with a specific color and/or a specific channel in a chip sorting machine.

2. The electronic marker of claim 1 comprising a circuitry capable of receiving data from a color sensor or from a position on a marking tree and being able to forward that data in a format associating a determined color and/or channel with the absolute economic value.

3. The electronic marker of claim 2 wherein the color sensor is part of the electronic marker.

4. The electronic marker of claim 1 wherein the marker has transmission capability for the value information.

5. The electronic marker of claim 1 wherein the marker has transmission capability for the value information and the color information.

6. The electronic marker of claim 1 wherein the marker has transmission capability for the color information.

7. The electronic marker of claim 1 wherein the marker has transmission capability for the value information and the color information.

8. An electronic value marking tree comprising a plurality of chip boards containing information related to an absolute economic value that can be assigned to a wagering chip, a receptor for a wagering chip that informationally associates a wagering chip color and/or assigned channel with a single chip board containing information related to an absolute economic value, and an informational communication component having external communication capability.

9. The marking tree of claim 8 wherein the chip boards containing information related to an absolute value also contain a color sensor.

10. The marking tree of claim 8 wherein the chip boards containing information related to an absolute value are removable from and insertable into marker receptors on the marker tree.

11. The marking tree of claim 10 wherein each marker receptor has an associated chip receptor.

12. The marker tree of claim 9 wherein the information communication component is communicatively linked to the color identifier and to the chip boards containing information related to an absolute value, and the information communication component is capable of communicating information from the color identifier and the single chip board so that an absolute economic value is associated with an individual color of wagering chip.

13. The marker tree of claim 12 wherein the external communication component is a wireless communication component.

14. The marker tree of claim 10 wherein the information communication component is communicatively linked to the color identifier and to the chip boards containing information related to an absolute value, and the information communication component is capable of communicating information from the color identifier and the single chip board so that an absolute economic value is associated with an individual color of wagering chip.

15. The marker tree of claim 14 wherein the external communication component is a wireless communication component.

16. The marker tree of claim 12 wherein each wagering chip acceptor can receive only a single wagering chip at a time.

17. The marker tree of claim 12 wherein each wagering chip acceptor can receive multiple wagering chips at one time.

18. The marker tree of claim 14 wherein each wagering chip acceptor can receive only a single wagering chip at a time.

19. The marker tree of claim 12 wherein each wagering chip acceptor can receive multiple wagering chips at one time.

20. The marker tree of claim 12 wherein the information communication component is in ultimate information communication with a chip sorter.

21. The marker tree of claim 14 wherein the information communication component is in ultimate information communication with a chip sorter.

22. A method for temporarily assigning value to individually colored wagering chips comprising positioning the colored wagering chip adjacent to an electronic source of value information, sending both color and/or position information from the wagering chip and value information from the source to a processor, and basing valuation of wagering chips that are counted in a finite period of time upon both the color and/or position information and value information assigned to that color.

23. The method of claim 22 wherein pairs of slots are provided, a colored wagering chip is inserted into a first slot of a pair of slots comprising a wagering chip acceptor, the electronic source comprises a chip board having electronic information and is inserted into a second slot of an opposed pair of slots and comprises a chip board receptor, and color information is obtained from the wagering chip acceptor or a location of the acceptor and value information is obtained from the electronic source to form color-value information, and that color-value information is transmitted to a device external to the electronic source.

24. The method of claim 23 wherein transmitted color and/or position and value information is sent to a data processor that has access to totals of chips according to color.

25. The method of claim 24 wherein the data processor calculates a value of wagering chips for a particular color based upon the color-value information and a total of chips of a color included in the color-value data.

26. The method of claim 22, wherein each chip acceptor is pre-assigned a chip color corresponding to a chip channel located within a chip sorting machine.
